(19) United States
(12) Patent Application Publication
(10) Pub. No.: US 2003/0119955 A1
(43) Pub. Date: Jun. 26, 2003

(54) Polymeric structural support membrane

(75) Inventors: Nancy A. Dulzer, Lyndhurst, OH (US); Jeffrey T. Champa, Mentor, OH (US); Michael Porsch, Minneapolis, MN (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(73) Assignee: MBT Holding AG

(21) Appl. No.: 10/260,847

(22) Filed: Sep. 30, 2002

Related U.S. Application Data
(63) Continuation-in-part of application No. 10/068,124, filed on Feb. 5, 2002.
(60) Provisional application No. 60/267,301, filed on Feb. 8, 2001.

(51) Int. Cl. C08K 3/34

(52) U.S. Cl. 524/127; 524/431; 524/432; 524/449; 524/558

(57) ABSTRACT

A polymeric structural support membrane composed of a polymer that is an initiator induced reaction product of a monomer, a co-monomer, an initiator, and optionally a crosslinking agent and a fire retardant, is applied to the surfaces of an excavation to provide structural support. The polymer is a reaction product of a monofunctional monomer and co-monomer. The membrane formed has a tensile strength and a thickness sufficient to provide support to the exposed surfaces in the excavation and can be applied by spraying, brushing, pumping or rolling.

### CROSS REFERENCE TO RELATED APPLICATIONS

This application is a continuation in part of U.S. Serial No. 10/068,124, filed on Feb. 5, 2002 which claims priority from U.S. Provisional Patent Application 60/267,301, filed Feb. 8, 2001, both of which are incorporated herein by reference.

### BACKGROUND

When ground is excavated, structural supports are placed in the excavation to prevent the ground from collapsing into the excavated area. Mainly, the ground is supported by support rods that are placed along the excavation. These supports are typically steel reinforcing rods that are held in place by mechanical anchors and/or grouts. These supports provide the main protection against unplanned rock falls.

The excavation, however, exposes natural rock features, such as faults and joints, and can damage the ground by digging or blasting. In these excavations, such as mines, supports are needed to prevent rock falls. Structural beams provide the main support in the excavation to prevent major rock falls. However, minor rock falls can occur between the main supports. Even though they may be isolated or relatively small, they still pose a hazard to people working in the excavation.

To prevent these minor rock falls between the supports, wire screens or mesh have been installed between the main supports. There are many disadvantages to using a wire screen. The screen requires labor intensive installation. The screen offers no protection against weathering of the rock face. Because of the unevenness of the rock face, the screen is not fully flush with the rock face. The screen only becomes effective after considerable rock movement puts tension on the screen. The screen is prone to corrosion and deterioration. The screen is prone to blasting damage if it is installed close to the advancing face. Because it cannot be installed remotely, it is hazardous to install because of falling rock. It can be difficult to shotcrete over which causes relatively high rebound and lower substrate adhesion.

One possible alternative to a wire mesh would be to spray concrete (shotcrete) onto the rock face. However, this would be cost prohibitive to apply to all surfaces in an excavation. Also, shotcreting may not be able to be applied in all locations.

Sealants have been used in mines to prevent air leaks. Sealants, however, are not capable of providing structural support to a surface in an excavation. Generally, sealants are polymer in water dispersions. As a result, they cannot be applied to a surface at a thickness sufficient to provide support because of the water content. Also, the polymer in water dispersion prohibits quick setting of the polymer on the surface, which in turn does not provide sufficient tensile strength.

What is needed in the art is a structural membrane that can be installed with minimal labor, can be installed remotely from the exposed rock face, offers weathering protection to the rock face, does not corrode, becomes effective with minimal rock deformation, can be applied near the advancing face, is less prone to blast damage, and can be covered with shotcrete if deemed necessary.

It is desirable to provide a polymeric structural support membrane for providing support to exposed surfaces in an excavation.

It is also desirable to provide a polymeric structural support membrane that has a tensile strength and thickness, and molecular weight that are sufficient to provide support to exposed surfaces in an excavation.

### SUMMARY

A polymeric excavation structural support membrane is provided which comprises a polymer that is an initiator induced reaction product of a monomer, a co-monomer, an initiator, a fire retardant, and optionally at least one of a crosslinking agent, a smoke retardant, a rheology modifier, a reaction rate modifier, a plasticizer, an emulsifier, a defoamer, a filler, and a coloring agent; wherein the monomer is selected from the group consisting of aryloxy alkyl acrylates, aryloxy alkyl methacrylates, and mixtures thereof; wherein the co-monomer is selected from the group consisting of alkyl ester acrylates, alkyl ester methacrylates, and mixtures thereof, wherein the membrane has a tensile strength and thickness sufficient to provide support to exposed surfaces in an excavation.

A polymeric excavation structural support membrane is further provided which comprises a polymer that is an initiator induced reaction product of a monomer, a co-monomer, an initiator, a crosslinking agent, a fire retardant, and optionally at least one of a smoke retardant, a rheology modifier, a reaction rate modifier, a plasticizer, an emulsifier, a defoamer, a filler, and a coloring agent; wherein the monomer is selected from the group consisting of monofunctional aryloxy alkyl acrylates, monofunctional aryloxy alkyl methacrylates, and mixtures thereof; wherein the co-monomer is selected from the group consisting of monofunctional alkyl ester acrylates, monofunctional alkyl ester methacrylates, and mixtures thereof.

A method is provided of reinforcing exposed surfaces in an excavation with a polymeric structural support membrane comprising: applying to the exposed surface a mixture comprising a monomer, a co-monomer, an initiator, a fire retardant; and optionally at least one of a crosslinking agent, a smoke retardant, a rheology modifier, reaction rate modifier, a plasticizer, emulsifier, defoamer, filler, and coloring agent; wherein the monomer is selected from the group consisting of aryloxy alkyl acrylates, aryloxy alkyl methacrylates, and mixtures thereof, wherein the co-monomer is selected from the group consisting of alkyl ester acrylates, alkyl ester methacrylates, and mixtures thereof, and reacting the mixture; wherein the membrane has a tensile strength and thickness sufficient to provide support to the exposed surfaces in the excavation.

Also provided is a polymeric structural support membrane formed from the process comprising: applying to an exposed surface in an excavation a mixture comprising a monomer, a co-monomer, an initiator, a fire retardant; and optionally at least one of a crosslinking agent, a smoke retardant, a rheology modifier, reaction rate modifier, a plasticizer, emulsifier, defoamer, filler, and coloring agent; wherein the monomer is selected from the group consisting of aryloxy alkyl acrylates, aryloxy alkyl methacrylates, and mixtures thereof, wherein the co-monomer is selected from the group consisting of alkyl ester acrylates, alkyl ester methacrylates, and mixtures thereof, and reacting the mixture; wherein the membrane has a tensile strength and a thickness sufficient to provide support to the exposed surfaces in the excavation.

The monomer is selected from the group consisting of monofunctional aryloxy alkyl acrylates, monofunctional aryloxy alkyl methacrylates, and mixtures thereof.

The co-monomer is selected from the group consisting of monofunctional alkyl ester acrylates, monofunctional alkyl ester methacrylates, and mixtures thereof.

### DETAILED DESCRIPTION

The present invention is directed to a polymeric structural support membrane for excavations. The membrane includes a polymer and a fire retardant.

The polymer is a reaction product of a monofunctional monomer and a monofunctional co-monomer. By functional, it is meant that the monomer has at least one double bond reactive group that can react in a polymerization reaction through a double bond to form a polymer. Additionally, the monomer can include another functional group, which can be a double bond or another reactive group, that reacts to link one polymer chain to another polymer chain.

The polymer is present in the membrane in an amount that provides the membrane with a tensile strength and thickness sufficient to provide support to exposed surfaces in an excavation. The polymer is generally present in an amount from about 25% to about 70% based on the weight of the membrane. In one embodiment, the polymer is present in the membrane from about 30% to about 50% based on the weight of the membrane.

The monofunctional monomers used according to the present invention are monofunctional esters, such as monofunctional aryloxy alkyl acrylates, monofunctional aryloxy alkyl methacrylates, and mixtures thereof. The methacrylates are preferred because they produce less odor.

The monofunctional co-monomers used according to the present invention include monofunctional esters, such as monofunctional alkyl ester acrylates, monofunctional alkyl ester methacrylates, and mixtures thereof. The methacrylates are preferred because they produce less odor. The co-monomer is generally present in an amount from about 15% to about 40% based on the weight of the monomer.

Examples of monofunctional aryloxy alkyl acrylates and monofunctional aryloxy alkyl methacrylates include, but are not limited to, 2-phenoxyethyl methacrylate, 2-phenoxy-propyl-methacrylate, and mixtures thereof.

Examples of monofunctional alkyl ester acrylates and monofunctional alkyl ester methacrylates include, but are not limited to hydroxypropyl methacrylate and hydroxypropyl acrylate.

In one embodiment the polymer is the reaction product of a monomer that is at least one of monofunctional aryloxy alkyl acrylates, monofunctional aryloxy alkyl methacrylates, or mixtures thereof; a co-monomer that is at least one of monofunctional alkyl ester acrylates, monofunctional alkyl ester methacrylates, or mixtures thereof; and a crosslinking agent.

In one embodiment, during the reaction process a selected monofunctional monomer and co-monomer form polymers that crosslink by reacting with the crosslinking agent thereby providing structural support for the membrane. Suitable examples of the crosslinking agent include, but are not limited to, neopentylglycol dimethacrylate or diacrylate, 1,6-hexanediol dimethacrylate, ethoxylated bisphenol A dimethacrylate, polyethylene glycol dimethacrylate or diacrylate, polypropylene glycol diacrylate or dimethacrylate, propoxylated trimethylolpropane triacrylate, ethoxylated trimethylpropane triacrylate, ethoxylated trimethylolpropane triacrylate, propoxylated glyceryl triacrylate di-trimethylolpropane tetra acrylate, dipentaerythritol tetra acrylate, tetraacrylate ester and mixtures thereof. The crosslinking agent can be present up to about 30% based on the weight of membrane.

As the membrane is being applied in an excavation, particularly in a mine, there is the potential for fire. In each jurisdiction, there are requirements that the membrane be self extinguishing. The test is performed by holding the membrane to a flame for a fixed period of time. The membrane must then self extinguish itself within a set maximum time.

Provided in the membrane is a fire retardant. The fire retardant can be any material that provides self extinguishing properties to the membrane. Suitable examples of the fire retardant include, but are not limited to, metal oxides which include aluminum oxides, such as aluminum hydroxide trihydrate, phosphates, such as triphenyl phosphate, polyammonium phosphate, monoammonium phosphate, or tri(2-chloroethyl) phosphate, exfoliated graphite (which can be acid treated natural graphite flakes), and mixtures thereof. The fire retardant is preferably present in the membrane from about 20% to about 60% based on the weight of the membrane.

The fire retardant can be a liquid or a solid. In certain embodiments the fire retardant is a solid. In other embodiments the solid is micronized. By micronized it is meant that the solid is ground to a micron size. Additionally, the fire retardant includes but is not limited to self extinguishing agents and flame retardants. Optionally, an aluminum oxide smoke retardant is used in combination with the polyammonium phosphate.

As stated above, a smoke retardant can be provided in the membrane. In certain embodiments the smoke retardant is aluminum oxide (Al₂O₃). Preferably, the smoke retardant is present in the membrane from about 20% to about 50% based on the weight of the membrane. No, the correct amount is 20 to 50% by weight of the membrane.

The gel and set time of the membrane can be controlled by adding at least an initiator. The initiator can be an oxidizing agent. Suitable oxidizing agents include, but are not limited to, peroxides, such as benzoyl peroxide, dibenzoyl peroxide, hydroperoxides, such as cumyl hydroperoxide, persulfates, such as ammonium persulfate, and mixtures thereof. The initiator is preferably added in an amount from about 0.5% to about 10% based on the weight of the membrane.

In combination with the initiator, a reaction rate modifier, such as an accelerator, can be added. The reaction rate modifier can be a reducing agent. Suitable reducing agents include, but are not limited to, aniline containing compounds, amines, glycols, octoates, and mixtures thereof. Suitable examples of the reaction rate modifier include, but are not limited to, triethanolamine, N,N-dimethyl-p-toluidine, and tripropyl amines. The reaction rate modifier can be present in an amount up to about 3% based on the weight of the membrane

The materials to form the membrane can either be provided as a single composition, or the materials can be provided as a two or more component formulation. The two or more component system may be desired when an initiator and a reaction rate modifier are being provided for in the membrane. In this instance, the initiator would be supplied in one component, and the reaction rate modifier could be supplied in another component.

The membrane can also include a rheology modifier to increase the viscosity of the membrane materials immediately after application to excavation surfaces. This may be desired to prevent the membrane from slumping before it cures when it is applied to a surface in an excavation. Suitable examples of the rheology modifier include fumed silica, hydroxyethyl cellulose, hydroxypropyl cellulose, fly ash (as defined in ASTM C618), mineral oils (such as light naphthenic), tetra alkyl ammonium hectorite clay, any other solids that are inert to the other materials in the membrane, and mixtures thereof. The rheology modifier can be present in an amount up to about 20% based on the weight of the membrane

The membrane can also include an emulsifier. It may be desired to add an emulsifier to increase the adhesion of the membrane to a surface. The emulsifier can be any anionic surfactant or nonionic surfactant. Suitable examples of the emulsifier include, but are not limited to, ethoxylated nonyl phenol (preferably, the ethoxylated nonyl phenol contains from about 4 to about 10 ethylene oxide groups), lauryl sulfates and mixtures thereof. The emulsifier can be present in an amount up to about 5% based on the weight of the membrane.

The membrane can also contain a plasticizer to make the membrane more flexible. The plasticizer can be any material that plasticizes the polymer in the membrane. In one embodiment of the invention, the plasticizer allows the polymer to be self plasticizing. In this instance, the monomer is reacted with the plasticizer that incorporates itself into the reaction product. The plasticizer can be present in an amount up to about 40% based on the weight of the membrane. Suitable examples of the plasticizer include, but are not limited to, ethoxylated(4) nonyl phenol (meth)acrylate, as shown by the following formula:

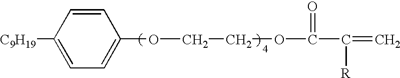

wherein R is H or CH₃.

The membrane can also include a filler. Suitable examples of the filler include, but are not limited to glass, such as crushed glass, metal such as iron particles, quartz, silica, barytes, limestone, sulfates, alumina, various clays, diatomaceous earth, wollastonite, mica, perlite, flint powder, kryolite, alumina trihydrate, talc, sand, pyrophylite, granulated polyethylene, fibers such as polypropylene or steel, zinc oxide, titanium dioxide, and mixtures thereof. A preferred filler is titanium dioxide. The filler can be present in an amount up to about 40% based on the weight of the membrane.

The membrane can also include a coloring agent, such as a pigment or a dye, to provide a desired color to the membrane. An example of a coloring agent is titanium dioxide, but other coloring agents are also useful. The coloring agent can be present in an amount up to about 5% based on the weight of the membrane.

The membrane can also include a defoamer such as modified silicones or petroleum oil mixtures. A preferred defoamer is FOAMASTER™ S available from Cognis Corporation, Cincinnati, Ohio. The defoamer can be present in an amount up to about 3% based on the weight of the membrane.

In one embodiment the membrane is formed from a two component reaction mixture. The first component includes the monomer, a co-monomer, the fire retardant, and the crosslinking agent that react to become the polymeric membrane, and may include any other additive, for example a a smoke retardant, a rheology modifier, reaction rate modifier, a plasticizer, emulsifier, defoamer, filler, and coloring agent. The second component comprises the initiator and may include any other additive listed above. In the two component mixture the monomer and co-monomer do not prematurely react with the initiator. To form the membrane, the two components are mixed and allowed to react.

When applied to a surface, the membrane is at least about 1.5 mm thick. Preferably, the membrane is about 2 mm to about 6 mm thick.

One property of the membrane is elongation. Elongation is the percent increase in length of a membrane before it breaks (ASTM D638). It is desired to achieve elongation in the shortest amount of time. In certain embodiments after 24 hours from being formed the membrane has an elongation greater than about 25%. In other embodiments, the membrane has an elongation greater than about 50% after 8 hours. In further embodiments, the membrane has an elongation greater than about 75% after 2 hours. In some embodiments, however, the membrane has an elongation of about zero. In these instances, the membrane is substantially rigid.

Another property of the membrane is tensile strength. Tensile strength is the maximum force that a membrane can withstand before breaking (ASTM D638). It is desired to achieve a high tensile strength. In certain embodiments, the membrane has a tensile strength greater than about 1 MPa after 24 hours. In other embodiments, the membrane has a tensile strength greater than about 1 MPa after 6 hours. In further embodiments, the membrane has a tensile strength greater than about 1 MPa after 30 minutes or less.

The membrane also has an adhesion property. Adhesion is measured by the force needed to remove the membrane from a surface (ASTM D4142). It is desired to achieve adhesion in the shortest amount of time. In certain embodiments, the membrane has an adhesion strength greater than about 0.5 MPa after 24 hours. In other embodiments, the membrane has an adhesion strength greater than about 1 MPa after 8 hours. In further embodiments the membrane has an adhesion strength greater than about 0.5 MPa after 30 minutes or less

The membrane can have water resistance. Water resistance can be determined by the following standards: ASTM D2247 (Standard Practice for Testing Water Resistance of Coatings in 100% Relative Humidity), ASTM D1735 (Standard Practice for Testing Water Resistance of Coatings Using Water Fog Apparatus), ASTM D4585 (Standard Practice for Testing Water Resistance of Coatings Using Controlled Condensation), or ASTM D870 (Standard Practice for Testing Water Resistance of Coatings Using Water Immersion).

The preferred standard is ASTM D870. A sample of the membrane is immersed in room temperature water for a period of about 24 hours. The tensile strength of the membrane is then measured and compared to the tensile strength of the membrane before immersion. Greater water resistance is indicated by having a lower loss in tensile strength. Acceptable water resistance is having a loss in tensile strength less than about 10%. Preferably, the loss in tensile strength is less than about 5%. It has been found that aryloxy alkyl acrylates and aryloxy alkyl methacrylates provide acceptable water resistance to the membrane of the present invention.

The membrane is also capable of quick set. By quick set it is meant that the membrane achieves at least one of the tensile, elongation, and adhesive properties within the time referenced above.

It is also preferred that the membrane have a useful service life greater than one year. By useful service life, it is meant that the membrane has less than about 10% loss of properties in one year.

Because the membrane may be applied underground in a mine, it is preferred that the membrane be non-toxic to human contact.

In another embodiment of the present invention there is provided a method of reinforcing exposed surfaces in an excavation with a polymeric structural support membrane. The method includes providing a mixture of a polymer that is an initiator induced reaction product of a monomer, a co-monomer, a fire retardant; and optionally at least one of a crosslinking agent, a smoke retardant, a rheology modifier, reaction rate modifier, plasticizer, emulsifier, defoamer, filler, and coloring agent; wherein the monomer is at least one of aryloxy alkyl acrylates, aryloxy alkyl methacrylates, and mixtures thereof; wherein the co-monomer is at least one of an alkyl ester acrylate, an alkyl ester methacrylate, or mixtures thereof; wherein the membrane has a tensile strength and a thickness sufficient to provide support to exposed surfaces in an excavation; and applying said mixture to an exposed surface in an excavation. This method provides for applying the above described polymeric structural support membrane on an exposed surface.

The mixture can be applied by spraying, brushing, or rolling to provide the polymeric structural support membrane on an exposed surface. An embodiment of the present invention is prepared from the following formulation. It is provided in a two component formulation with the monomer and co-monomer being provided in one part and the initiator in another part of the formulation.

PART A

| | |
|---|---|
| 2-phenoxyethyl methacrylate | Monomer |
| neopentylglycol dimethacrylate | Cross-linking agent |
| Hydroxypropyl methacrylate | Co-monomer |
| N,N-Dimethyl-P-Toluidine | Reaction rate modifier |
| aluminum hydroxide trihydrate | Flame retardant/fire retardant |
| fumed silica | Rheology modifier |
| mineral oil (light naphthenic) | Rheology modifier |
| titanium dioxide | Coloring agent, filler |
| FOAMASTER S | Defoamer |

PART B

| | |
|---|---|
| tricresyl phosphate | Fire retardant |
| mineral oil (light naphthenic) | Rheology modifier |
| benzoyl peroxide | Initiator |
| fumed silica | Rheology modifier |
| talc | Inert filler |
| FOAMASTER S | Defoamer |

In another embodiment, the present invention is prepared from the following formulation. Again, this embodiment is provided in a two component formulation with the monomer and co-monomer, being provided in one part and the initiator in another part the formulation.

PART A

| | |
|---|---|
| 2-phenoxyethyl methacrylate | Monomer |
| Hydroxypropyl methacrylate | Co-monomer |
| neopentylglycol dimethacrylate | Cross-linking agent |
| N,N-Dimethyl-P-Toluidine | Reaction rate modifier |
| ethoxylated(4) nonyl phenol (meth)acry- | Plasticizer |
| late | |
| aluminum hydroxide trihydrate | Fire retardant/smoke retardant |
| fumed silica | Rheology modifier |
| mineral oil (light naphthenic) | Rheology modifier |
| talc | Inert filler |
| titanium dioxide | Coloring agent, filler |
| FOAMASTER S | Defoamer |

PART B

| | |
|---|---|
| Tricresyl phosphate | Fire retardant/smoke retardant |
| benzoyl peroxide | Initiator |
| mineral oil (light naphthenic) | Rheology modifier |
| fumed silica | Rheology modifier |
| FOAMASTER S | Defoamer |

### EXAMPLE 1

An example of the present inventive polymeric structural support membrane was tested for tensile strength ASTM D638 and elongation ASTM D638 both in the presence of water and without water. The example of the invention comprises two components (3 parts of Part A to 1 part of Part B (by weight)) which were added together to react and form the support membrane. In part A three monomers were used in order to maximize the flexibility (elongation), strength (tensile strength) and water sensitivity of the structural support membrane. 2-phenoxyethyl methacrylate imparts decreased water sensitivity but lacks strength and flexibility whereas, the remaining two monomers hydroxy propyl methacrylate and isobornyl methacrylate give the membrane strength and flexibility.

TABLE 1

% of total
mixture weight

Part A

| | | |
|---|---|---|
| Monomer (mixture) | 2-phenoxyethyl methacrylate | 37.59 |
| Co-monomer | hydroxy propyl methacrylate | 22.55 |
| Co-monomer | isobornyl methacrylate | 15.04 |
| Cross-linking agent | ethyoxylated bisphenol A | 3.78 |
| | dimethacrylate | |
| Reaction rate modifier | N,N-dimethyl-p-toluidine | 0.53 |
| Flame retardant/ | Grafguard 220-80B | 5.66 |
| self-extinguishing agent | | |
| Rheology modifier | Bentone 38 | 11.71 |
| | Aerosil R 202 | 1.89 |
| Coloring agent, filler | Titanium dioxide | 0.90 |
| Defoamer | Foamaster S | 0.35 |

Part B

| | | |
|---|---|---|
| Self-extinguishing agent | tri(2-chloroethyl)phosphate | 74.63 |
| Initiator | benzoyl peroxide | 14.93 |
| Rheology modifier | Bentone 38 | 7.46 |
| | Aerosil R 202 | 2.98 |

TABLE 1.1
Measured Membrane Property

| | | |
|---|---|---|
| @ 1 hr. | @ 1 day | @ 7 days |

Air Cure

| | | | |
|---|---|---|---|
| Tensile strength (MPa) | 1.3 | 1.5 | 1.3 |
| Elongation (%) | 140 | 129 | 113 |

Moist Cure

| | | |
|---|---|---|
| Tensile strength (MPa) | 1.5 | 1.1 |
| Elongation (%) | 120 | 136 |

The example was tested for elongation (ASTM D638)—the percent increase in length of a membrane before it breaks, and tensile strength (ASTM D638)—the maximum force that a membrane can withstand before breaking expressed in megapascals. As illustrated by the results in Table 1.1, the polymeric structural support membrane achieves the desired tensile strength (greater than 1 MPa after 24 hours) and elongation (greater than about 25% after 24 hours). Therefore, the membrane will display the desired strength and flexibility for an underground structural support. Additionally, the test results demonstrate that the polymeric structural support membrane shows little or no strength loss when exposed to water (moisture sensitivity).

### EXAMPLE 2

Examples were prepared with hydroxy propyl methacrylate (HPMA) alone, 2-phenoxyethyl methacrylate (PEM) alone, and the combination of HPMA/PEM, and were tested for tensile strength ASTM D638 and elongation ASTM D638, both in the presence of water and without water.

TABLE 2

| | | HPMA | | HPMA/PEM 4:1 | | PEM | |
|---|---|---|---|---|---|---|---|
| | | tensile | elonga- | tensile | elonga- | tensile | elonga- |
| | | strength | tion | strength | tion | strength | tion |
| | | [MPa] | [%] | [MPa] | [%] | [MPa] | [%] |
| 1 hour | | 6.48* | 3.9* | 3.41 | 41 | 2.42* | 46* |
| 1 day | air | 7.76 | 3.7 | 3.17 | 38 | 2.11 | 43 |
| | water | 4.61 | 2.9 | 3.1 | 41 | 2.19 | 48 |
| 7 days | air | 11.19* | 2.8* | | | 1.89 | 38 |
| | water | 0.71 | 102 | | | 1.98 | 53 |

The examples were tested for elongation (ASTM D638)—the percent increase in length of a membrane before it breaks, and tensile strength (ASTM D638)—the maximum force that a membrane can withstand before breaking expressed in megapascals (MPa). As demonstrated in Table 2 the tensile strength of HPMA is drastically reduced when exposed to water, measuring 0.71 MPa compared to 11.19 MPa when exposed to air. While PEM had a lower overall tensile strength, it was not affected by water, measuring 1.98 MPa when exposed to water compared to 1.89 MPa when exposed to air. When the HPMA and PEM were combined, a membrane with increased tensile strength over PEM was achieved without the loss of strength when exposed to water as observed with the HPMA alone, measuring 3.17 MPa in air and 3.1 MPa in water. Additionally, the wet substrate adhesion of the HPMA/PEM polymer was increased which is an unexpected result, as HPMA has decreased performance in wet environments (reduced tensile strength).

### EXAMPLE 3

Examples of the present inventive polymeric structural support membrane were tested for tensile strength ASTM D638, elongation ASTM D638, substrate adhesion ASTM D4142, both in the presence of water (wet) and without water. In the wet examples the concrete substrate was immersed overnight in water prior to conducting the test. The examples of the invention comprise two components which were added together to react and form the support membrane.

TABLE 3

| | | Mix | Mix | Mix |
|---|---|---|---|---|
| | | 1 | 2 | 3 |
| | | % | % | % |
| | Part A | | | |
| Monomer | SR340 (2-phenoxyethyl | 34.26 | 22.84 | 11.42 |
| | methacrylate) | | | |
| Co-monomer | SR248 (hydroxy propyl | 11.42 | 22.84 | 34.26 |
| | methacrylate) | | | |
| Cross Linking Agent | ethyoxylated bisphenol A | 0.99 | 0.99 | 0.99 |
| | dimethacrylate | | | |
| Defoamer | Foamaster S | 0.30 | 0.30 | 0.30 |
| Reaction rate modifier | N,N-dimethyl-p-toluidine | 0.31 | 0.31 | 0.31 |
| Fire/Smoke Retardant | aluminum hydroxide | 50.00 | 50.00 | 50.00 |
| | trihydrate | | | |
| Rheology Modifier | R202 | 2.72 | 2.72 | 2.72 |
| | Part B | | | |
| Fire Retardant | Tri Butyl Phosphate | 32.00 | 32.00 | 32.00 |
| Filler | Talc 300 | 55.20 | 55.20 | 55.20 |
| Coloring Agent | TiO2 | 3.00 | 3.00 | 3.00 |
| Rheology Modifier | R202 | 5.00 | 5.00 | 5.00 |
| Initiator | BFF 50 | 4.80 | 4.80 | 4.80 |

% = percent of total mixture weight

TABLE 3.1

| | Mix 1 | Mix 2 | Mix 3 |
|---|---|---|---|
| | Tensile Strength, MPa | | |
| 1 hour | 2.54 | 4.62 | 12.32 |
| 1 day, dry | 1.93 | 4.40 | 11.46 |
| 1 day, wet | 1.79 | 3.21 | 6.37 |
| 7 days, dry | 1.72 | 3.80 | 8.62 |
| 7 days, wet | 1.31 | 1.71 | 1.85 |
| | Elongation, % | | |
| 1 hour | 28.4 | 16.3 | 8.9 |
| 1 day, dry | 28.10 | 13.30 | 5.30 |
| 1 day, wet | 36.40 | 17.40 | 5.00 |
| 7 days, dry | 36.60 | 17.00 | 2.38 |
| 7 days, wet | 31.10 | 52.30 | 55.70 |
| Bond, MPa | 0.28 | 1.49 | 1.72 |
| 1 hour, wet (avg 3) | | | |

Table 3.1 demonstrates that as the amount of HPMA was increased in the polymer, the more wet substrate adhesion increased, varying from 0.28 MPa to 1.72 MPa as the amount of HPMA increased. Further, the tensile strength and elongation % increased with additional amounts of HPMA.

Although the invention has been described in detail through the above detailed description and the preceding formulations and example, these examples are for the purpose of illustration only and it is understood that variations and modifications can be made by one skilled in the art without departing from the spirit and the scope of the invention.

Further all embodiments disclosed are not necessarily in the alternative, various embodiments of the invention may be combined to provide the desired characteristics.

What is claimed is:

1. A polymeric excavation structural support membrane comprising a polymer that is an initiator induced reaction product of a monomer, a co-monomer, an initiator, a fire retardant, and optionally at least one of a crosslinking agent, a smoke retardant, a rheology modifier, a reaction rate modifier, a plasticizer, an emulsifier, a defoamer, a filler, and a coloring agent; wherein the monomer is selected from the group consisting of aryloxy alkyl acrylates, aryloxy alkyl methacrylates, and mixtures thereof; wherein the co-monomer is selected from the group consisting of alkyl ester acrylates, alkyl ester methacrylates, and mixtures thereof, wherein the membrane has a tensile strength and thickness sufficient to provide support to exposed surfaces in an excavation.

2. A polymeric excavation structural support membrane comprising a polymer that is an initiator induced reaction product of a monomer, a co-monomer, an initiator, a crosslinking agent, a fire retardant, and optionally at least one of a smoke retardant, a rheology modifier, a reaction rate modifier, a plasticizer, an emulsifier, a defoamer, a filler, and a coloring agent; wherein the monomer is selected from the group consisting of monofunctional aryloxy alkyl acrylates, monofunctional aryloxy alkyl methacrylates, and mixtures thereof; wherein the co-monomer is selected from the group consisting of monofunctional alkyl ester acrylates, monofunctional alkyl ester methacrylates, and mixtures thereof.

3. The polymeric structural support membrane of claim 1 or 2, wherein the polymer is present in an amount from about 25 % to about 70% by weight of the membrane, the fire retardant is present from about 5% to about 60% by weight of the membrane, and the initiator is present from about 0.5% to about 10% by weight of the membrane.

4. The polymeric structural support membrane of claim 3, wherein the polymer is present in an amount from about 30% to about 50% by weight of the membrane.

5. The polymeric structural support membrane of claim 1 or 2, wherein the co-monomer is present in an amount of from about 15% to about 40% based on the weight of the monomer.

6. The polymeric structural support membrane of claim 2, wherein the monofunctional aryloxy alkyl methacrylates are selected from the group consisting of 2-phenoxyethyl methacrylate, 2-phenoxy-propyl-methacrylate, and mixtures thereof.

7. The polymeric structural support membrane of claim 1 or 2, wherein the fire retardant is selected from the group consisting of phosphates, metal oxides, exfoliated graphite, and mixtures thereof.

8. The polymeric structural support membrane of claim 7, wherein the phosphate is selected from the group consisting of polyammonium phosphate, monoammonium phosphate, triphenyl phosphate, tri(2-chloroethyl) phosphate, and tricresyl phosphate.

9. The polymeric structural support membrane of claim 1 or 2, wherein the initiator is an oxidizing agent.

10. The polymeric structural support membrane of claim 9, wherein the oxidizing agent is selected from the group consisting of peroxides, hydroperoxides, persulfates, and mixtures thereof.

11. The polymeric structural support membrane of claim 10, wherein the peroxide is selected from the group consisting of benzoyl peroxide and dibenzoyl peroxide.

12. The polymeric structural support membrane of claim 10, wherein the persulfate is ammonium persulfate.

13. The polymeric structural support membrane of claim 10, wherein the hydroperoxide is cumyl hydroperoxide.

14. The polymeric structural support membrane of claim 1 or 2, wherein the crosslinking agent is selected from neopentylglycol dimethacrylate or diacrylate, 1,6-hexanediol dimethacrylate, ethoxylated bisphenol A dimethacrylate, polyethylene glycol dimethacrylate or diacrylate, polypropylene glycol diacrylate or dimethacrylate, propoxylated trimethylolpropane triacrylate, ethoxylated trimethylpropane triacrylate, ethoxylated trimethylolpropane triacrylate, propoxylated glyceryl triacrylate di-trimethylolpropane tetra acrylate, dipentaerythritol tetra acrylate, tetraacrylate ester and mixtures thereof.

15. The polymeric structural support membrane of claim 1 or 2, wherein the smoke retardant is aluminum oxide.

16. The polymeric structural support membrane of claim 1 or 2, further characterized by at least one of the following:
a. the crosslinking agent is present up to about 15% by weight of the membrane;
b. the rheology modifier is present up to about 20% by weight of the membrane;
c. the emulsifier is present up to about 5% by weight of the membrane;
d. the plasticizer is present up to about 40% by weight of the embrane;
e. the filler is present up to about 40% by weight of the membrane;
f. the coloring agent is present up to about 5% by weight of the membrane;
g. the defoamer is present up to about 3% by weight of the membrane;
h. the reaction rate modifier is present up to about 3% by weight of the membrane; and
i. the smoke retardant is present up to about 50% by weight of the membrane.

17. The polymeric structural support membrane of claim 1 or 2, wherein the emulsifier is selected from the group consisting of anionic surfactants, nonionic surfactants, and mixtures thereof.

18. The polymeric structural support membrane of claim 17, wherein the emulsifier is selected from the group consisting of ethoxylated nonyl phenol, lauryl sulfates, and mixtures thereof.

19. The polymeric structural support membrane of claim 1 or 2, wherein the rheology modifier is selected from the group consisting of fumed silica, hydroxyethyl cellulose, hydropropyl cellulose, fly ash, mineral oil, tetra alkyl ammonium hectorite clay, and mixtures thereof.

20. The polymeric structural support membrane of claim 1 or 2, wherein the reaction rate modifiers are reducing agents.

21. The polymeric structural support membrane of claim 20, wherein the reducing agents are selected from the group consisting of anilines, amines, glycols, octoates, and mixtures thereof.

22. The polymeric structural support membrane of claim 1 or 2, wherein the filler is selected from the group consisting of crushed glass, metal selected from the group consisting of iron particles, silica, barytes, limestone, sulfates, alumina, clays, diatomaceous earth, wollastonite, mica, perlite, flint powder, kryolite, talc, sand, pyrophylite, granulated polyethylene, fibers selected from the group consisting of polypropylene and steel, aluminum oxide, zinc oxide, titanium dioxide, and mixtures thereof.

23. The polymeric structural support membrane of claim 1 or 2, wherein the plasticizer is ethoxylated(4) nonyl phenol (meth)acrylate.

24. The polymeric structural support membrane of claim 1 or 2, wherein the membrane is at least about 1.5 mm thick.

25. The polymeric structural support membrane of claim 24, wherein the membrane is about 2 mm to about 6 mm thick.

26. The polymeric structural support membrane of claim 1 or 2, wherein the membrane is characterized by at least one of:
a. an elongation greater than about 25% after about 24 hours from being formed;
b. an elongation greater than about 50% after about 8 hours from being formed;
c. an elongation greater than about 75% after about 2 hours from being formed;
d. a tensile strength greater than about 1 MPa after about 24 hours from being formed;
e. a tensile strength greater than about 1 MPa after about 6 hours from being formed;
f. a tensile strength greater than about 1 MPa within about 30 minutes from being formed;
g. an adhesion strength greater than about 0.5 MPa after about 24 hours from being formed;
h. an adhesion strength greater than about 1 MPa after about 8 hours from being formed;
i. an adhesion strength greater than about 0.5 MPa within about 30 minutes from being formed; and
j. a water resistance having less than about 10% loss of tensile strength when measured by immersion in room temperature water for about 24 hours.

27. The polymeric structural support membrane of claim 1 or 2, wherein the membrane is a reaction product of a first component and a second component; wherein the first component comprises a monomer, a co-monomer, and optionally a crosslinking agent, a smoke retardant, a rheology modifier, a reaction rate modifier, a plasticizer, an emulsifier, a defoamer, a filler, and a coloring agent; and the second component comprises the initiator and optionally a smoke retardant, a rheology modifier, a reaction rate modifier, a plasticizer, an emulsifier, a defoamer, a filler, and a coloring agent.

28. The polymeric structural support membrane of claim 27, wherein the membrane is a reaction product of a first component and a second component; wherein the first component comprises a monomer, a co-monomer, a crosslinking agent, a reaction rate modifier, a self-extinguishing agent, a rheology modifier, a filler, and a defoamer; and the second component comprises an initiator, a self-extinguishing agent, a rheology modifier, and a defoamer.

29. The polymeric structural support membrane of claim 27, wherein the first component comprises 2-phenoxyethyl methacrylate, hydroxypropyl methacrylate, neopentylglycol dimethacrylate, N,N-dimethyl-p-toluidine, fumed silica, titanium dioxide, smoke retardant, and defoamer; and wherein the second component comprises phosphate, benzoyl peroxide, fumed silica, and defoamer.

30. The polymeric structural support membrane of claim 27, wherein the first component comprises 2-phenoxyethyl methacrylate, hydroxpropyl methacrylate, and optionally neopentylglycol dimethacrylate, N,N-dimethyl-p-toluidine, ethoxylated(4) nonyl phenol (meth)acrylate, polyammonium phosphate, aluminum oxide, fumed silica, mineral oil, titanium dioxide, zinc borate, and defoamer; and wherein the second component comprises polyammonium phosphate, aluminum oxide, mineral oil, benzoyl peroxide, fumed silica, zinc borate, and defoamer.

31. A method of reinforcing exposed surfaces in an excavation with a polymeric structural support membrane comprising:
a. applying to the exposed surface a mixture comprising a monomer, a co-monomer, an initiator, a fire retardant, and optionally at least one of a crosslinking agent, a smoke retardant, a rheology modifier, a reaction rate modifier, a plasticizer, an emulsifier, a defoamer, a filler, and a coloring agent; wherein the monomer is selected from the group consisting of aryloxy alkyl acrylates, aryloxy alkyl methacrylates, and mixtures thereof, wherein the co-monomer is selected from the group consisting of alkyl ester acrylates, alkyl ester methacrylates, and mixtures thereof, and
b. reacting the mixture;
wherein the membrane has a tensile strength and thickness sufficient to provide support to the exposed surfaces in the excavation.

32. The method of claim 31, wherein said applying is selected from the group consisting of spraying, brushing, rolling, pumping and combinations thereof.

33. The method of claim 31, wherein the tensile strength is at least 1 MPa and the thickness is about 1.5 mm to about 6 mm.

34. A polymeric structural support membrane formed from the process comprising:
a. applying to an exposed surface in an excavation a mixture comprising a monomer, a co-monomer, an initiator, a fire retardant; and optionally at least one of a crosslinking agent, a smoke retardant, a rheology modifier, reaction rate modifier, a plasticizer, emulsifier, defoamer, filler, and coloring agent; wherein the monomer is selected from the group consisting of aryloxy alkyl acrylates, aryloxy alkyl methacrylates, and mixtures thereof, wherein the co-monomer is selected from the group consisting of alkyl ester acrylates, alkyl ester methacrylates, and mixtures thereof, and
b. reacting the mixture;
wherein the membrane has a tensile strength and thickness sufficient to provide support to the exposed surfaces in the excavation.

35. The polymeric structural support membrane of claim 34, wherein the tensile strength is at least 1 MPa and the thickness is at least about 1.5 mm.
